(19) United States
(12) Patent Application Publication
(10) Pub. No.: US 2005/0033662 A1
(43) Pub. Date: Feb. 10, 2005

(54) Method for visualizing differing types of window coverings within a room setting

(76) Inventors: James Buch, Palos Verdes Estates, CA (US); Robert Atland, Aliso Viejo, CA (US); David Humphreys, Anaheim, CA (US); Randall Beck, Orange, CA (US); Francis Arigo, Corona, CA (US)

Correspondence Address: Kit M. Stetina, Esq.;STETINA BRUNDA GARRED & BRUCKER, 75 Enterprise, Suite 250, Aliso Viejo, CA, 92656, US

(21) Appl. No.: 10/633,827

(22) Filed: Aug. 4, 2003

(51) Int. Cl. G06F 17/60

(52) U.S. Cl. 705/27

(57) ABSTRACT

A computer implemented method for allowing a user to visualize differing types of window coverings within a room setting is disclosed. A room setting user interface including a plurality of available room settings is provided. A selected room setting is obtained from the user via the room setting user interface. A product user interface including a plurality of available products is provided. A selected product is obtained from the user via the product user interface. A color user interface including a plurality of available colors for the selected product is provided. A selected color is obtained from the user via the color user interface. A visualization of the selected product in the selected color in the selected room setting is displayed. The method can also be used for visualizing other home décor products, such as area rugs or throw pillows.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to digital imaging systems and more particularly to a digital imaging system for visualization of differing types of window coverings within a room setting including a customer's own room setting.

Many homeowners are spending substantial amounts of time and money in the upgrading/remodeling of their homes. This has been especially true with changes in the economy, including low interest rates. Homeowners feel that upgrading their homes is a wise investment.

Even though home owners may want to upgrade their homes, redecorating is a difficult task for most people because it is difficult to visualize various products, such as window coverings, in one's own home. A homeowner may want to change window coverings in one or more rooms. There are many styles of window coverings, such as blinds, shutters, shades, draperies. Even after the homeowner has decided on the type of window covering (e.g., shutters, blinds, etc.), there are many styles, such as vertical blinds, horizontal blinds, different sized slats, etc. Additionally, for any given product, the product may come in different materials, such as wood or vinyl. Additionally, each product is typically available in a variety of colors.

Sellers of window coverings, such as 3 Day Blinds® have been providing in-home design consultants in an attempt to solve the above-identified problem. Such in-home design consultation entails a sales/design representative traveling to the customer's site (e.g., home or business) with product (material) swatches, sample products (i.e., small versions of the window coverings, e.g., a 12″ square) and photographs of the various products. This helps give the customer a better idea of how the product will look as the prospective customer can hold the product swatches up to the walls in their home/office in order to select a desired product in a material and color that matches the existing décor. The in-home design consultant may also bring a book or deck of color samples, such as a deck or book of Pantone® colors. Pantone,® Inc. which is headquartered in Carlstadt, N.J., is a world-renowned authority on color and a provider of color systems and technology for the selection and accurate communication of color across a variety of industries. The PANTONE® name is known worldwide as the standard language for color communication from designer to manufacturer to retailer to customer. Even with the product and color samples, the prospective customer does not have a clear picture of what the actual product will look like in their setting until the product is actually ordered, delivered and installed.

Thus, there is a need for a system that allows a prospective customer to view different window coverings in the prospective customer's room setting.

### BRIEF SUMMARY OF THE INVENTION

A computer implemented method for allowing a user to visualize differing types of window coverings within a room setting is disclosed. A room setting user interface including a plurality of available room settings is provided. A selected room setting is obtained from the user via the room setting user interface. A product user interface including a plurality of available products is provided. A selected product is obtained from the user via the product user interface. A color user interface including a plurality of available colors for the selected product is provided. A selected color is obtained from the user via the color user interface. A visualization of the selected product in the selected color in the selected room setting is displayed.

The color user interface may include a color wheel that displays the selected color and a plurality of colors related to the selected color. The color user interface may include color variation strips based on colors displayed in the color wheel. The color user interface may highlight colors that have matching products.

The selected room setting may be a pre-stored glamour photograph or a photograph of the user's room setting.

If the room setting is a photograph of the user's room setting, the user may indicate a window location in the photograph using a pointing device, such as a mouse. The user may indicate a plurality of window locations in the photograph using the pointing device. If there are multiple window locations, different selected products may be displayed at different window locations or different colors of the same product may be displayed at different window locations.

The photograph of the user's room setting may be a digital photograph. The digital photograph may be accessed directly from the digital camera or the digital photograph may be stored on a disk, such as a hard disk or a floppy disk that is accessible by the computer on which the method is implemented.

A touch screen user interface may be used to obtain user input.

The method may be implemented on a portable computer, such as a laptop computer.

The selected product may be translucent and the level of transparency may be adjustable by the user.

The method may be implemented on a server that can be remotely accessed by the user over a network, such as the Internet.

The method may further allow the user to order the selected product in the selected color.

The method may be used for home décor products other than window coverings, such as area rugs, carpet and/or throw pillows.

### BRIEF DESCRIPTION OF THE DRAWINGS

These as well as other features of the present invention will become more apparent upon reference to the drawings wherein:

FIG. 1 is a flow diagram illustrating exemplary logic for a method for visualizing differing types of window coverings within a room setting;

FIG. 2 (FIGS. 2A-2B) is a flow diagram illustrating exemplary logic for a click stream for a system for visualizing differing types of window coverings within a room setting as shown in the exemplary logic of FIG. 1;

FIG. 3 is an exemplary splash screen for the system for visualizing differing types of window coverings within a room setting of FIG. 2;

FIG. 4 is an exemplary New Color menu displayed upon selection of a new color option from the exemplary user interface screen of FIG. 3;

FIG. 5 is an exemplary Load New Color user interface displayed upon selection of a Load New Color option selected from the new color user interface of FIG. 4;

FIG. 6 is an exemplary Load New Product Color user interface displayed upon selection of a Load New Product Swatch option selected from the New Color user interface of FIG. 4;

FIG. 7 is an exemplary Browse Products user interface displayed upon selection of a Browse Products option selected from the New Color user interface of FIG. 4;

FIG. 8 is an exemplary Browse Room Photos user interface displayed upon selection of a Browse Glamour Photos option selected from the New Color user interface of FIG. 4;

FIG. 9 is an exemplary Color Browser user interface including a color wheel that allows a user to select a Pantone® PICS color;

FIGS. 10-12 illustrate exemplary Matching Products user interface displays that allow a user to select a product to visualize; and

FIGS. 13-21 illustrate exemplary Visualization user interface displays that allow a user (prospective customer) to visualize different window treatment products in a room setting, including the user's own room setting.

### DETAILED DESCRIPTION OF THE INVENTION

The window covering visualization system described herein allows a prospective customer to view different window covering products in different colors as they would appear in the customer's home. In an exemplary embodiment described herein, an in-home design consultant goes to a prospective customer's home or other location (e.g., place of business) for which window coverings are desired. As in the past, the in-home consultant brings decks or swatches of various products so the prospective customer can see the material and colors used in various products. These decks or swatches include an identification code identifying the color of the sample. Additionally, the in-home design consultant brings a portable computer, such as a laptop computer that has the software program for the digital imaging system described herein loaded on the portable computer. Preferably, the in-home design consultant also brings a digital camera for taking photographs of the windows for which the window coverings are being considered. The in-home design consultant may also bring a deck of colors for the prospective customer to view as a starting point in the color selection process. Each of the color cards includes an identification of the color.

In exemplary embodiments, Pantone® colors are used. PANTONE® ColorWeb utilizes what is known as the PANTONE® Internet Color System (PICS), as a cross-platform, dither-free palette of numbered and chromatically organized colors, which is designed to provide Web designers with a method for using colors that can be viewed accurately, with the best possible results, regardless of monitor or platform. ColorWeb is made up of two parts: a printed swatch book for picking combinations of browser safe color and software that lets the user access the chromatically arranged colors directly with the Color Picker. As described above, in exemplary embodiments, the in-home consultant brings the printed swatch book to the site so that the prospective customer can select an initial color.

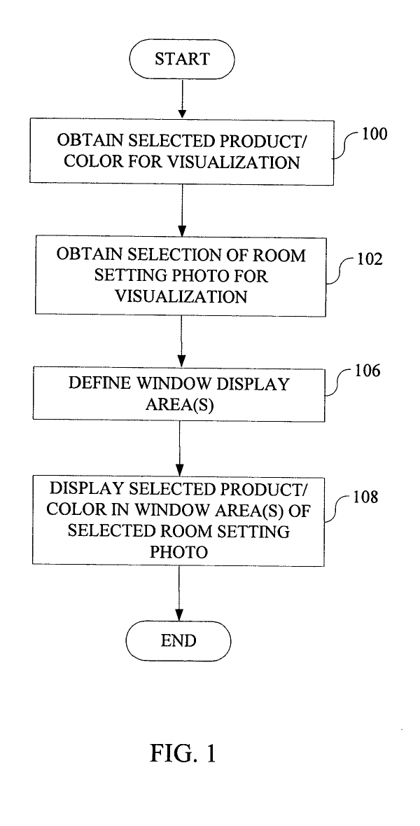

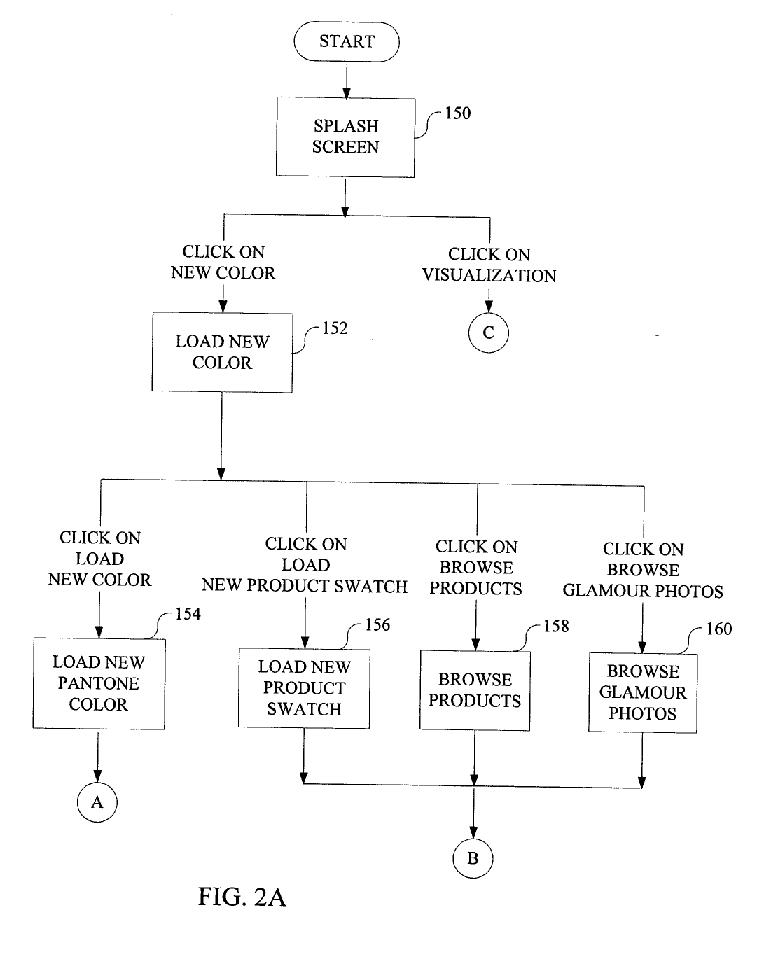

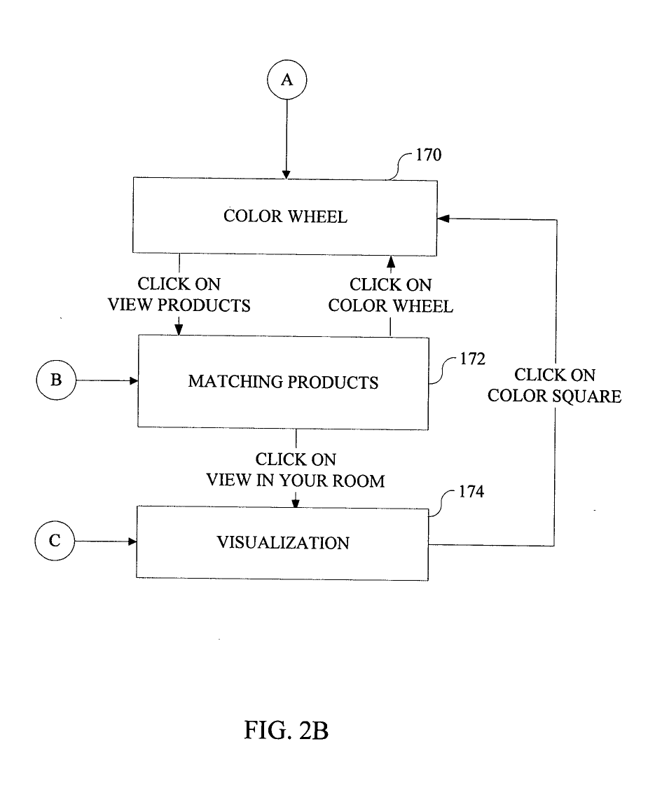

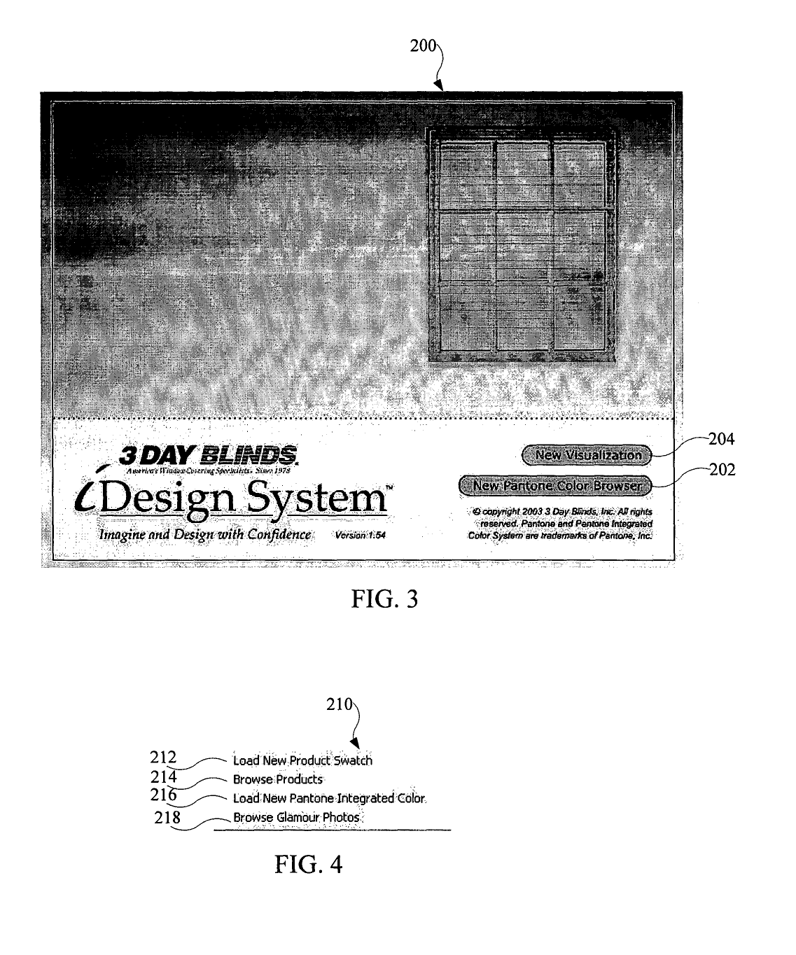

Referring now to the drawings wherein the showings are for purposes of illustrating preferred embodiments of the present invention only, and not for purposes of limiting the same, FIG. 1 is a flow diagram illustrating exemplary logic for a method for visualizing different window covering products in a room setting. FIG. 2 (FIGS. 2A and 2B) is a flow diagram illustrating exemplary logic for a click stream for a system for visualizing differing types of window coverings within a room setting such as is shown in the flow diagram of FIG. 1. FIGS. 3-20 are exemplary screen displays for a user interface for a system for visualizing different window covering products in a room setting as exemplified by the logic shown in the flow diagram of FIG. 1 and the click stream of FIG. 2 (FIGS. 2A and 2B).

The logic of FIG. 1 (and click stream logic shown in FIG. 2) begins upon execution of a window treatment visualization program. As described above, in exemplary embodiments, the program is run on a laptop computer. Exemplary embodiments of the program require the installation of .NET Framework (version 1.0 or higher) and Microsoft Data Access Components (MDAC) (version 2.6 or higher). The .NET Framework is a component of the Microsoft Windows® operating system and is used to build and run Windows-based applications.

The logic of FIG. 1 moves from a start block to block 100 where an available product is selected from a repository of available products (e.g., shutters, blinds, vertical blinds, etc.). As shown in the figures, a list of available products are shown in the user interfaces that allow the user to select a product. These user interfaces include a list of available colors for each available product. The user selects an available color for the available product. The logic moves to block 102 where a room setting photograph for visualization is selected. In exemplary embodiments, the room setting can be a glamour (pre-stored) photograph or a photograph of the prospective customer's room setting. The logic moves to block 106 where window display region(s) in the photo are defined. As described later, in exemplary embodiments, the user uses a pointing device, such as a mouse to draw a rectangle border around the window(s) shown in the photo. The logic proceeds to block 108 where the selected product is displayed on the windows of the photo in the selected color. Although not shown in FIG. 1, in exemplary embodiments, such as the one shown in the click stream of FIG. 2 and the user interface displays shown in FIGS. 3-20, the user may perform repeated visualization by changing colors, products or room setting photos as desired.

The click stream logic shown in FIG. 2A moves from a start block to block 150 where an initial screen is displayed. In exemplary embodiments, the initial screen is a Splash Screen 200 such as the one shown in FIG. 3. A splash screen (or splash page) is an initial page, such as a Web site page, that is used to capture the user's attention for a short time as a promotion or lead-in to the site home page. A splash screen can also be used to tell the user what kind of browser and other software they need to view the site. A splash page can be used to create effects or provide information that is only needed once a visit. For example, a user can keep coming back to the home page without having to be bothered with browser requirements. Some sites use “splash page” to mean the home page itself, especially where it contains attention-capturing visual or multimedia effects (creating a “splash”).

From the Splash Screen 200, the user can opt to select a new color (e.g., by pressing a New Pantone® Color Browser button 202) or to visualize a product in a room setting (e.g., by pressing a New Visualization button 204).

Referring to FIG. 2A, if the user selected the load new color option (e.g., the user pressed the New Pantone® Color button 202), the logic moves to block 152 to load a new color. Logic for loading a new color is described next. If the user selected the visualization option (e.g., the user pressed the New Visualization button 204), the logic moves to block 174 (FIG. 2B) where visualization logic is performed as described in further detail later.

If the user selected the load new color option, the logic moves to block 152. In exemplary embodiments, a New Color Browser menu 210 such as the one shown in FIG. 4 is displayed when a user presses the New Pantone® Color Browser button 202. The exemplary New Color Browser menu 210 shown in FIG. 4 allows the user to load a new product swatch (by selecting a Load New Product Swatch option 212), browse products (by selecting a Browse Products option 214), load a new color (by selecting a Load New Pantone Integrated Color option 216) or Browse Glamour Photos (by selecting a Browse Glamour Photos option 218).

If the user selects Load New Pantone Integrated Color 216, the logic proceeds to block 154 to load a new Pantone® color as described next. If the user selects Load New Product Swatch 212, the logic proceeds to block 156 to load a new product swatch as described later. If the user selects Browse Products 214, the logic proceeds to block 158 to browse product swatches as described later. If the user selects Browse Glamour Photos 218, the logic proceeds to block 160 to browse glamour photos as described later.

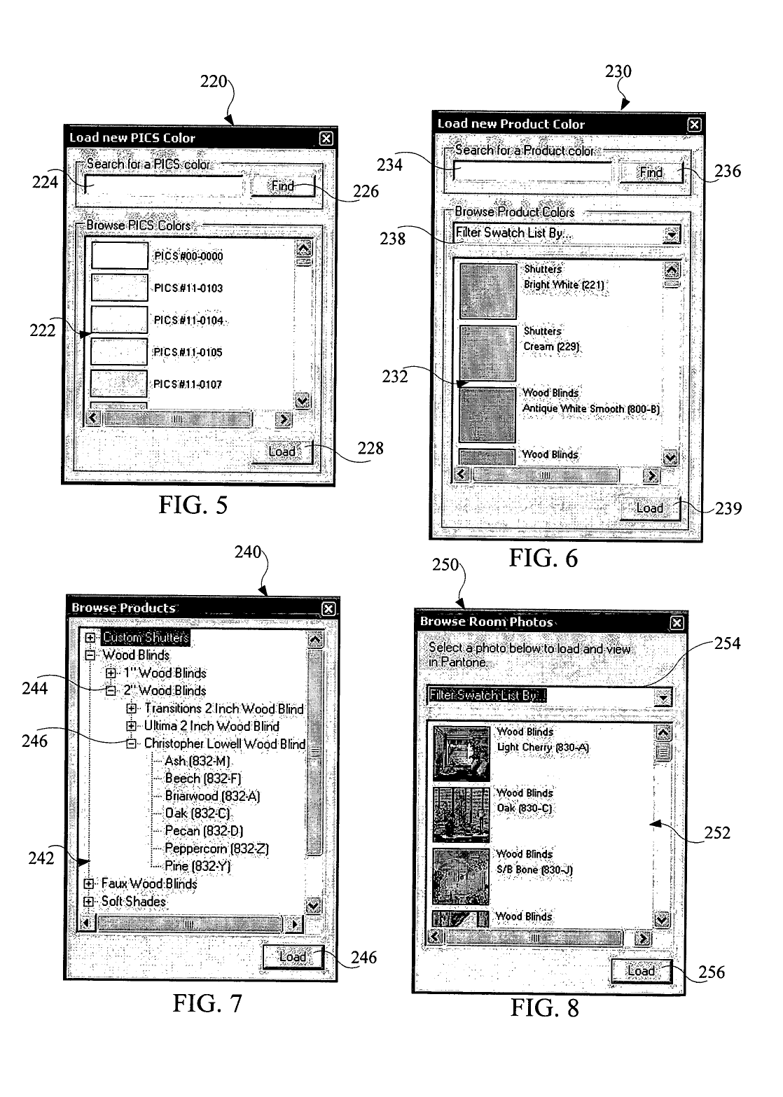

If the user selects Load New Pantone® Integrated Color 216, the logic proceeds to block 154 to load a new Pantone® color. A Load New PICS Color display 220, such as the one shown in FIG. 5 is displayed. The Load New PICS Color display 220 allows a user to select a color. In order to select a color, the user can enter a color identification in a color number box 224 and press a Find button 226. As described above, the in-home designer typically has a Pantone® color deck or book. A desired color can be selected from the deck or book and entered in the search box 224. The deck or book includes a PICS color identification number for each of the color samples in the deck or book. The at-home representative may have a Pantone® color meter that allows him/her to scan a color, such as paint on a wall. The Pantone® color meter provides the PICS color for the scanned item. Alternatively, the user can select a color by scrolling through a color list 222. In exemplary embodiments, the color list 222 includes all of the Pantone® colors. Some of the colors may not be used on any products while other colors may be used on one or more products. After a color has been selected (either by scrolling through the color list or entering a color in the search box 224 and pressing a Find button 226), the user presses a Load button 228 to store the chosen color as the selected color.

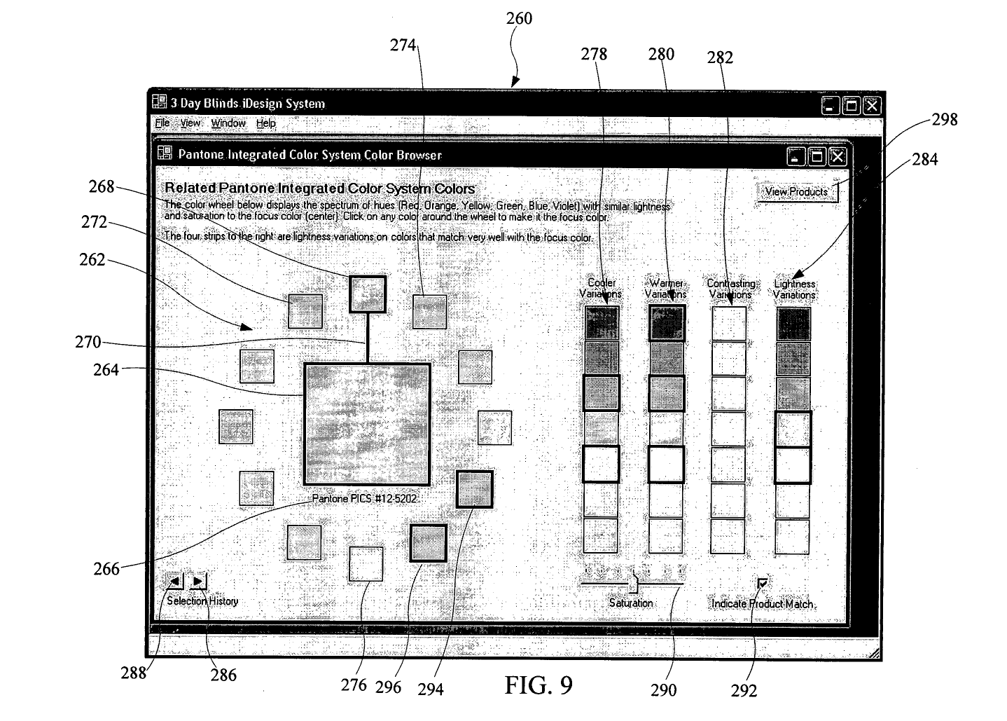

After the user has selected/loaded a new color from the Load New PICS color display 220 by pressing the Load button 228, the logic of FIG. 2A moves from block 154 to block 170 (FIG. 2B) w here a color browser display 260 including a color wheel 262 is displayed. An exemplary color browser display 260 is shown in FIG. 9. In exemplary embodiments, such as the one shown in FIG. 9, the selected color is displayed in a large area 264, such as a square, in the center of the color wheel 262. As described above, in exemplary embodiments, the color is a Pantone® color and the Pantone® PICS color identification 266 is displayed below the selected color 264. Twelve colors are displayed around the selected color spaced equally apart, like the numerals on a clock face. Related colors are displayed adjacent each other and complementary colors are displayed opposite each other. In the exemplary embodiment shown in FIG. 9, the selected color shown in the center of the color wheel 264 is also displayed at the twelve o'clock position 268. A line 270 is drawn from the center box 264 to the twelve o'clock box 268 to indicate that the colors in these boxes are the same color. Cooler colors are to the left of the selected color with the closest of the cooler colors being closest to the selected color, i.e., to the immediate left of the selected color in the eleven o'clock position 272. Warmer colors are to the right of the selected color with the closest of the warmer colors being positioned closest to the selected color, i.e., to the immediate right of the selected color in the one o'clock position 274. A contrasting color to the selected color is displayed opposite the selected color at the six o'clock position 276.

In the exemplary display, there are four strips of colors displaying variations of the selected color 264. The variation strips include: cooler variations of the selected color 278, warmer variations of the selected color 280, contrasting variations of the selected color 282 and lightness variations of the selected color 284. The strip of cooler variations 278 includes lighter and darker shades of the cooler color for the selected color (i.e., lighter and darker variations of the color to the immediate left of the selected color at the eleven o'clock position 272). The strip of warmer variations 280 includes lighter and darker shades of the warmer color for the selected color (i.e., lighter and darker variations of the color to the immediate right of the selected color at the one o'clock position 274). The strip of contrasting color variations 282 are lighter and darker shades of the contrasting color shown opposite the selected color at the six o'clock position 276. The strip of lightness variations 284 are lighter and darker shades of the selected color 264 on the color wheel 262.

In exemplary embodiments, clicking on any color shown on the screen (i.e., any color on the color wheel 262 or any color in any of the variation strips 278, 280, 282, 284) changes the selected color 264, 268 to the just clicked color. When the selected color is updated, all of the colors in the color wheel 262 and all of the colors in the color strips 278,280, 282, 284 are updated based on the new selected color.

In exemplary embodiments, there is a selection history that allows the user to scroll forward 286 and backward 288 through the selected colors. A saturation bar 290 allows the user to increase or decrease the color saturation for all colors displayed on the color wheel 262 and all colors displayed on the color strips 278, 280, 282, 284. If the user selects the Indicate Products Match option 292, all color squares having corresponding product matches will be highlighted, for example by displaying a darkened box around the squares having product matches. For example, in the color wheel 262 shown in FIG. 9, the selected color 264, 268 and the colors at the four o'clock position 294 and the five o'clock position 296 are highlighted indicating that there are available products in those colors. In the example shown in FIG. 9, some colors in some of the variation strips 278, 280, 284 are also highlighted to indicate that there are products available in the highlighted colors. When the selected color has one or more products available in the selected color 264, the View Products option 298 becomes enabled. For example, in the example shown, the View Products button 298 is disabled (displayed in gray) and cannot be selected until it is enabled. Once enabled, the View Products button 298 is enabled (un-grayed) and can be selected. In exemplary embodiments, the user can return to the load options display 210 (shown in FIG. 4) via a menu option and/or by right-clicking on any free space on the display.

In exemplary embodiments, if the user hovers over any color square, the Pantone® PICS number for that color is displayed. If the user hovers over a box that has any product matches, the matching products are listed.

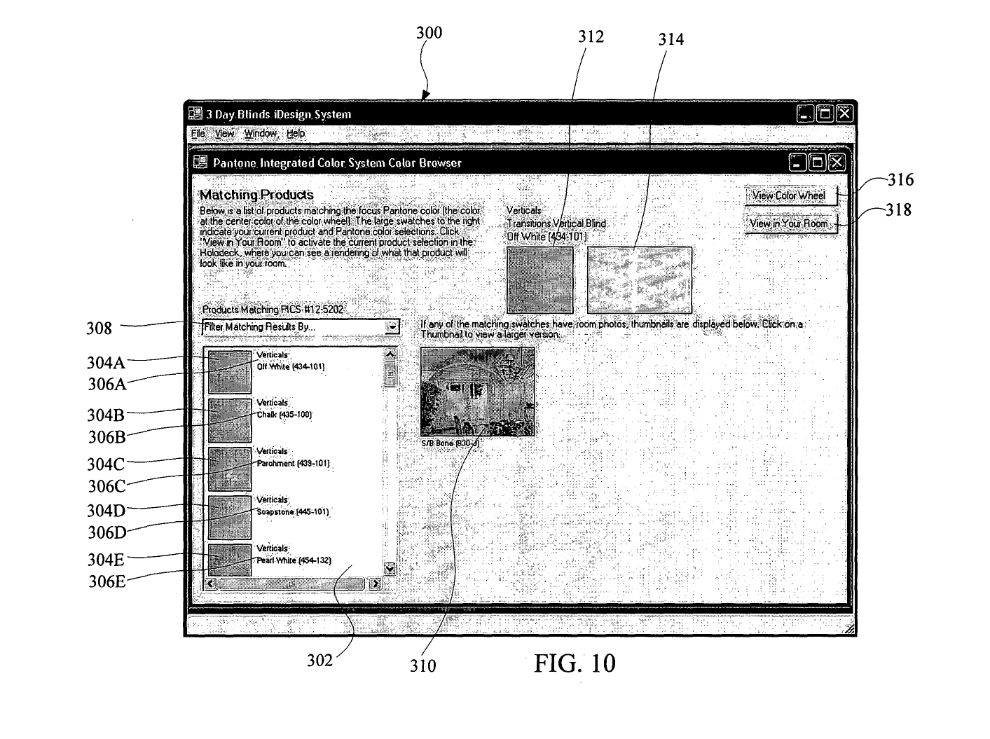

If the user selected the View Products option 298 from the Color Browser display 260, a Matching Products display 300 such as the one shown in FIG. 10 is displayed. The Matching Products display 300 includes a list of the products that have a match for the selected color number (PICS number) 302. Each of the products in the list 302 includes a thumbnail 304A, 304B, 304C, 304D, 304E of the product swatch and a textual product identification 306A, 306B, 306C, 306D, 306E that includes the product family and color as well as a product identification code. In exemplary embodiments, the product list 302 includes products that come in the selected color 264. If the user wishes to view products for any of the related colors on the display that have matches (e.g., are highlighted), the user selects the desired color.

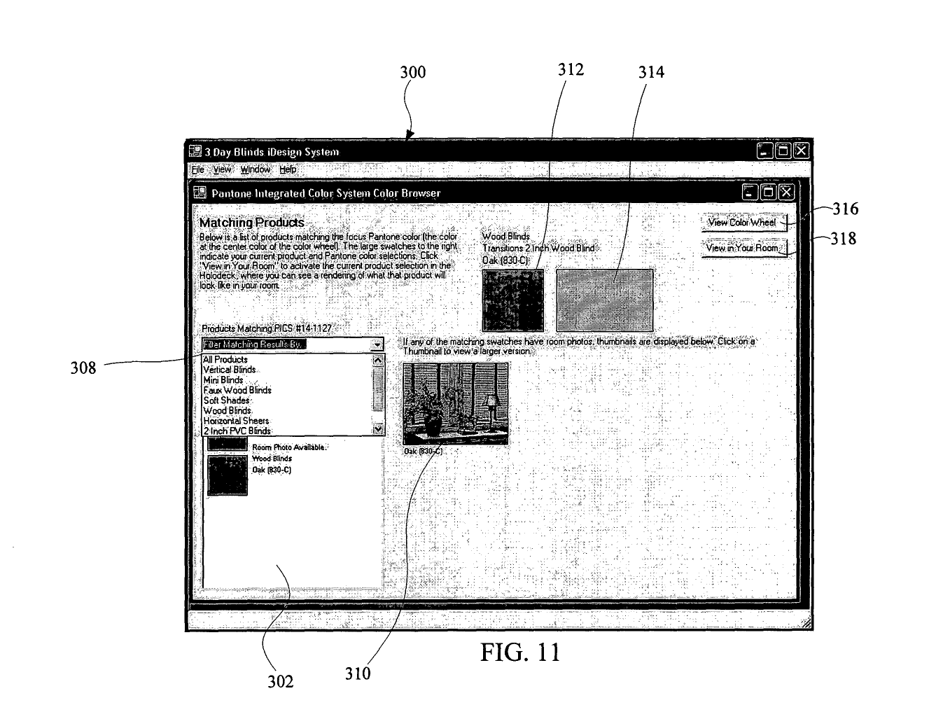

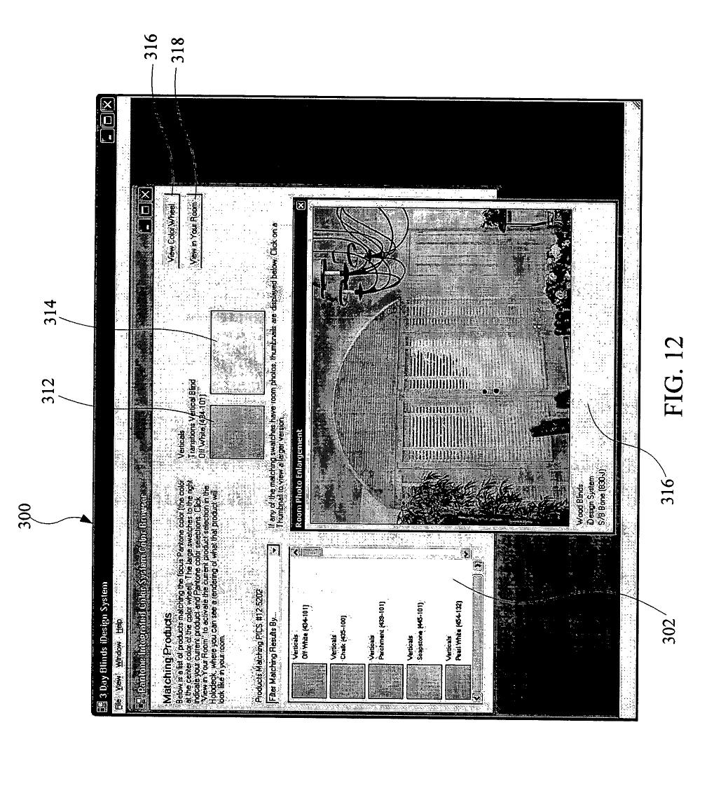

The list can be filtered by choosing a filter from a filter selection list 308. In exemplary embodiments, the filter selection list 308 allows the user to filter the list of products 302 based on product family (e.g., wood blinds, shutters, vertical blinds, etc.) as shown in FIG. 11.

When the user selects a product from the product list 302, a Pantone® color square 312 and a larger thumbnail of the product swatch 314 are displayed.

If any of the products have an associated glamour photo, the glamour photo 310 will be displayed. In exemplary embodiments, if the user clicks on the glamour photo 310, a larger window with the glamour photo 316 will be displayed as shown in FIG. 12.

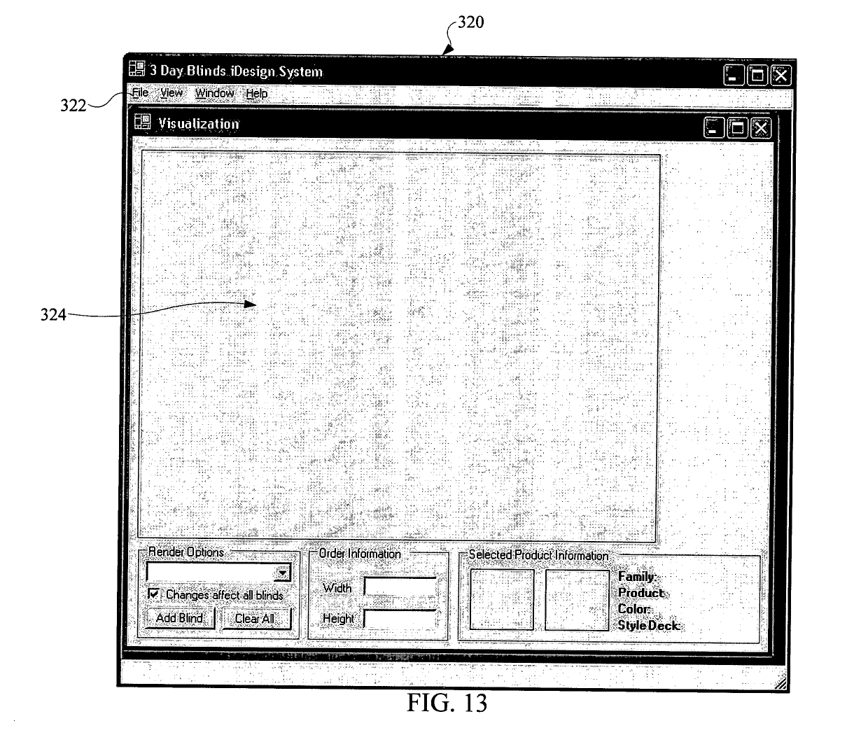

In exemplary embodiments such as the one shown in FIGS. 10-12, the Matching Products display 300 includes a View Color Wheel button 316 that allows the user to view a Color browser display 260 including a color wheel 262 such as the one shown in FIG. 9 and described above. In exemplary embodiments such as the one shown in FIGS. 10-12, the Matching Products display 300 also includes a View in Your Room button 318 that allows the user to visualize the selected product in their own room setting. FIG. 13 shows an exemplary Visualization display and is described later.

If the user selects Load New Product Swatch 212 from the New Color Browser menu 210, a Load New Product Color display 230, such as the one shown in FIG. 6 is displayed. The user can scroll through a list of swatches 232 which displays all of the available products in the available colors for the product. The user can filter the swatch list 232, by choosing the desired filter from a filter list 238. For example, in exemplary embodiments, the user can filter based on product. The user can also directly select a product/color by entering a product identification code in a search box 234 and then pressing a Find button 236. In the example shown in FIG. 6, if the user wanted to select Cream shutters, the user could select the product from the list 232 or enter the product code (e.g., 229 for Cream Shutters) in the Search box 234. After selecting the desired product/color, the user can load (store) the selected product/color by pressing a Load button 239. After the user has loaded a product/color, a Matching Products display 300 such as the one shown in FIG. 10 is displayed. An exemplary Matching products display 300 is shown in FIGS. 10-12 described above.

If the user selects Browse Products 214, from the New Color Browser Menu 210, a Browse Products display 240 such as the one shown in FIG. 7 is displayed. The browse products display 240 includes a text list of all available product types 242. The user can expand any of the product types (by pressing an expand/contract button) to view the available colors for that product type. For example, in FIG. 7, the user clicked the expansion button for 2″ Wood blinds 244 which displays the product types for 2″ wood blinds, which in the example shown includes Transitions 2 inch Wood Blinds, Ultima 2 inch Wood Blinds and Christopher Lowell Wood Blinds. The user then clicked the expansion button for Christopher Lowell Wood Blinds 246 which displays a list of the available colors for Christopher Lowell Wood Blinds. The list of products 242 includes the name of the color of the blind and a product code for the particular product for the specified color. The user can select a product and press a Load button 246 which causes the selected (i.e., highlighted) product/color to be loaded (stored) as the selected product/color. After the user has loaded a product/color, a Matching Products display 300 such as the one shown in FIG. 10 is displayed. An exemplary Matching products display 300 is shown in FIGS. 10-12 described above.

If the user selects Browse Glamour Photos 218 option from the New Color Browser menu 210, a Browse Room Photos display 250 such as the one in FIG. 8 is displayed. In exemplary embodiments, thumbnails of the available photos are shown in a list 252 along with a textual description (product and color) of the product in the photo. The photo list can be narrowed by use of a filter 254. For example, the list 252 can be filtered based on product family. After the user has loaded a product/color, a Matching Products display 300 such as the one shown in FIG. 10 is displayed. An exemplary Matching products display 300 is shown in FIGS. 10-12 described above.

As mentioned above, a prospective customer can visualize various window treatment products. The visualization can be done using glamour (pre-loaded) photos or using photos of the prospective customer's own room setting. In the exemplary embodiment described herein, the user can access a Visualization display via a Visualization option 204 on the Splash screen 200 (block 150 of FIG. 2A) or via a Matching Products display 260 (block 172 or FIG. 2B)

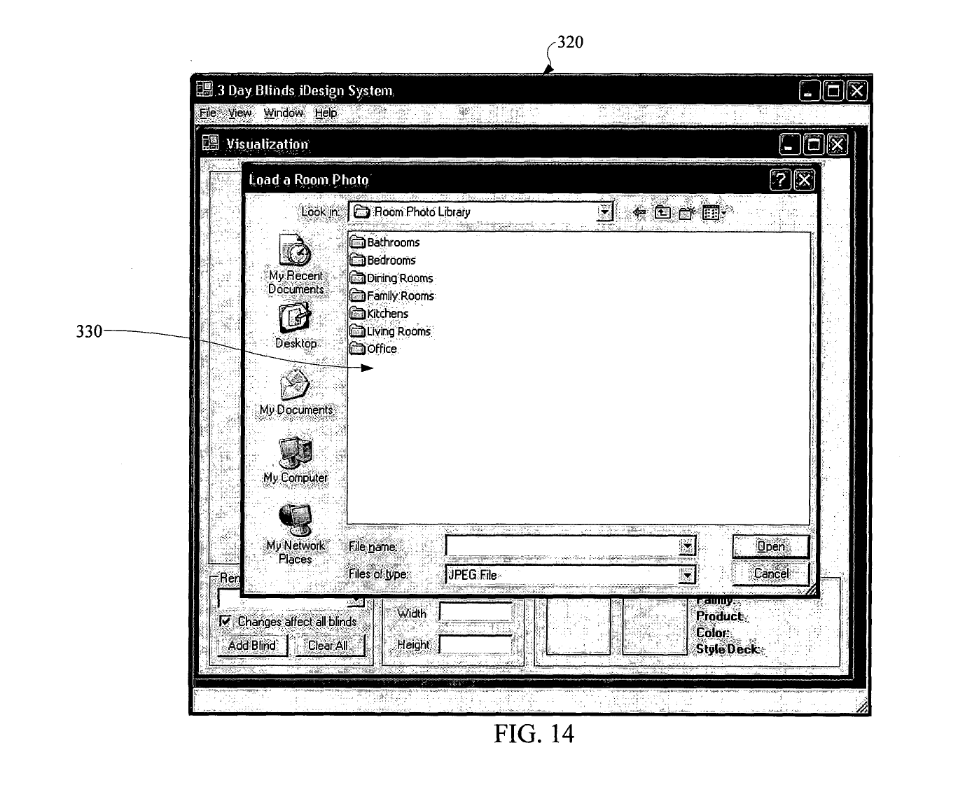

FIG. 13 illustrates an exemplary Visualization display 320. If the user wishes to perform visualization, a room picture is loaded from the file menu 322 or by right-clicking anywhere in the visualization form 324. The user can select a glamour photo (preloaded photo) or a photo of the user's home. The display will default to a room photo library with directories for different room types (e.g., dining rooms, kitchens, living rooms, bedrooms, bathrooms, etc) 330 as shown in FIG. 14.

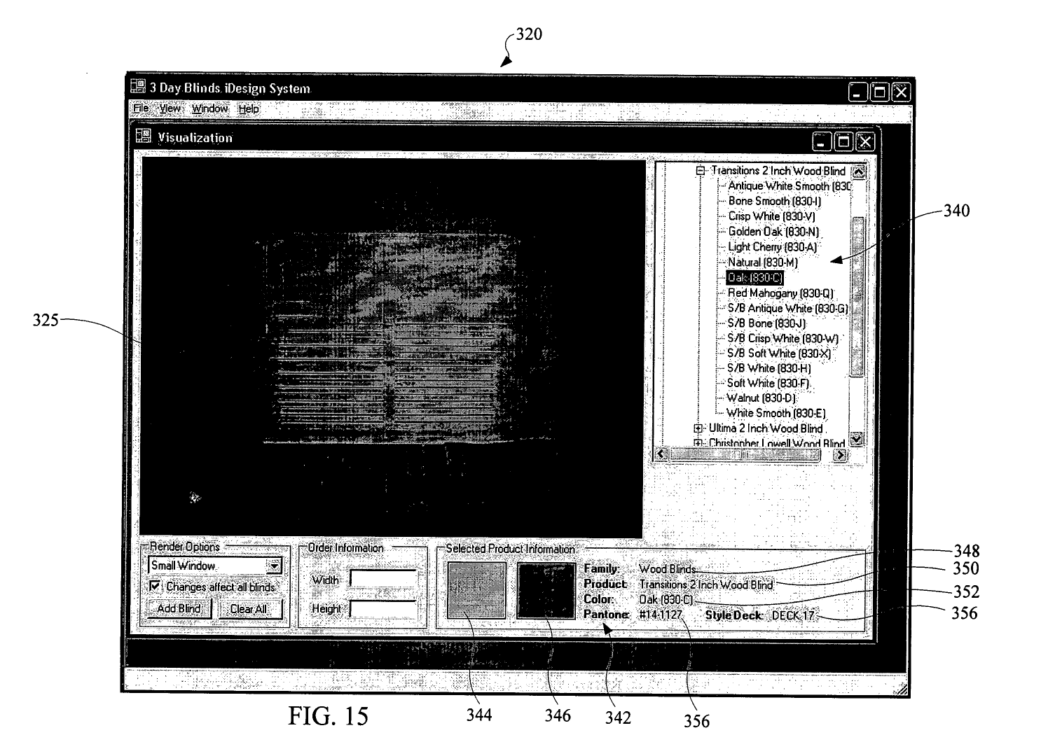

For new pictures (of the prospective customer's house) taken with a digital camera, the user can navigate to a desired picture that is stored in the connected digital camera or to a digital picture that has been previously stored on the computer. The selected photograph 325 is displayed in the visualization form 324. A products tree 340 is shown on the display as shown in FIG. 15. The products tree 340 is used to select the desired product to be visualized. The color defaults to the selected color, but can be changed. The product tree 340 includes the available colors for the selected product. The user can select a different color from the product tree 340.

Upon selection of a product/color from the product tree 340, a Pantone color square 344 and swatch photograph 346 are displayed in a selected product information area 342. Additional product information appears in the selected product information area 342. For example, this additional information may include a product family 348, a product name 350, a product color identification 352, a Pantone® PICS color identification 354 and a style deck 356. The style deck is a corresponding identification for a sample product deck provided by the manufacturer of the product.

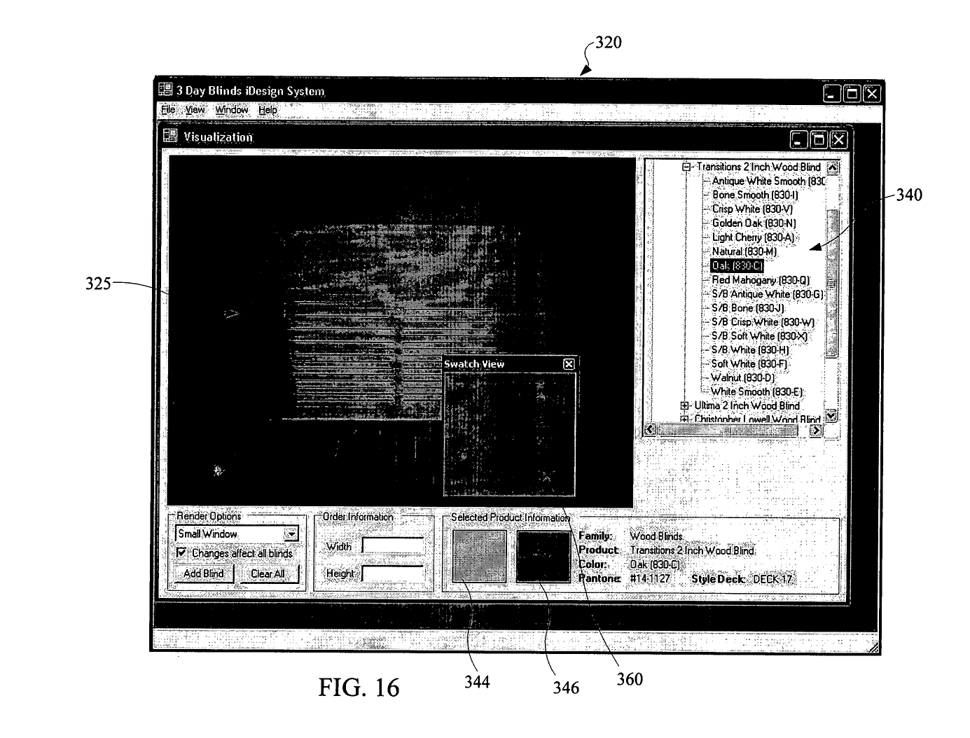

In exemplary embodiments, if the user clicks on the product swatch 346, a larger version of the swatch photograph 360 is displayed as shown in FIG. 16. In exemplary embodiments, if the user clicks on the Pantone color square 344, a Color Browser display 260, such as the one shown in FIG. 9 is displayed.

The window region (area to display the window coverings) must be defined. In exemplary embodiments, the user clicks on the upper left comer that is to define the window region and drags the mouse to the lower right comer to draw a rectangle that defines the window region.

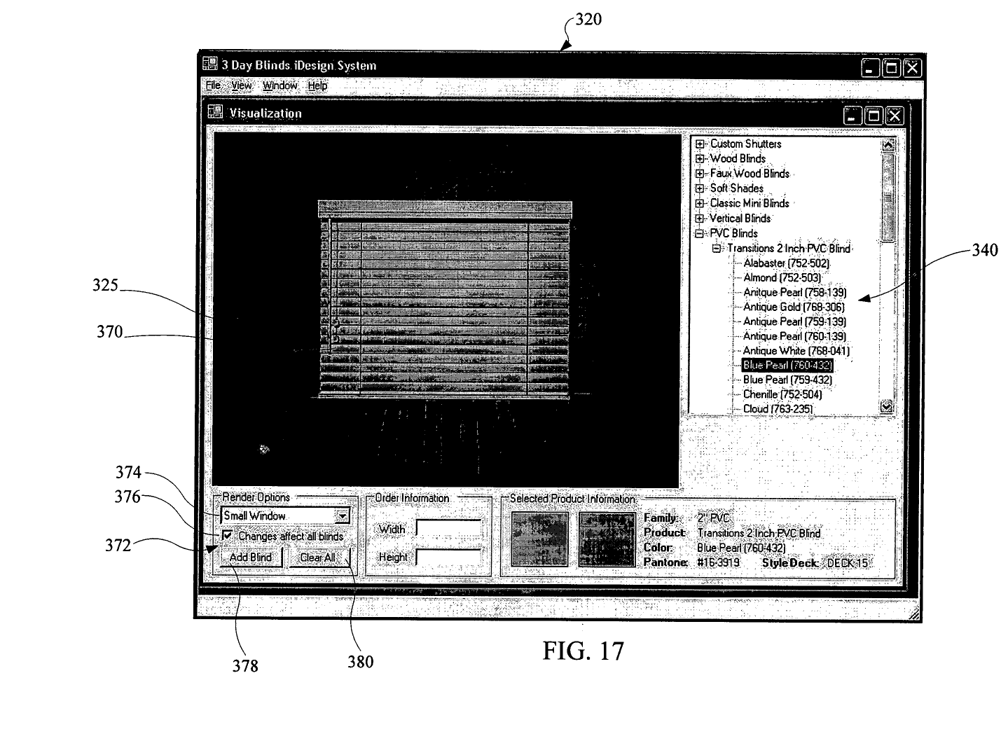

The user can select a new product and/or new color of a displayed product from the product tree 340. The new selected product is displayed in the defined window region 370 as shown in FIG. 17.

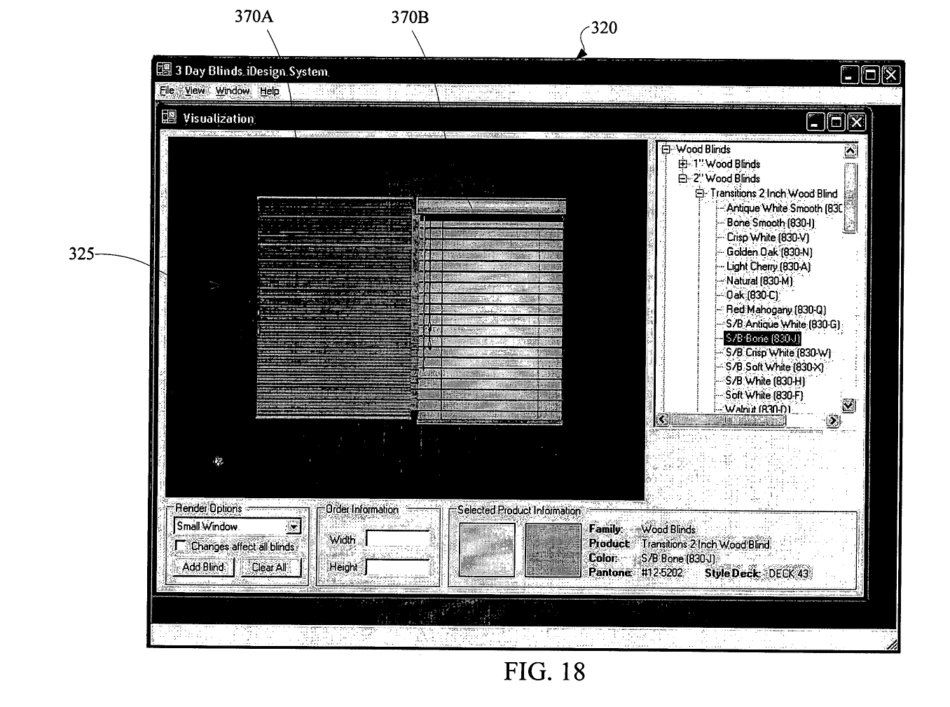

In exemplary embodiments, rendering is performed on the fly. In other embodiments, such as the one shown, rendering is not performed on the fly. To accommodate for stretching of the images and to mitigate how much the stretching will move the slats out of proportion, the user can change from a small window version to a large window version using a window size list 374 in a Render Options area 372. The smaller version has fewer slats that appear slightly bigger. This allows for windows of different dimensions and for pictures taken from different distances to be seen with blinds that are proportional to the window size. The Render Options area also includes an Add Blind button 378 that allows the user to define multiple window regions in the same photograph. Different blinds can be displayed in the different window regions as shown in FIG. 18. A Changes Affect All Blinds option 376 allows the user to specify whether a newly selected product is displayed in all defined window regions or only in the last defined window region.

The user may press a Clear All button 380 to start over. This removes the defined window region so the user can begin again with the loaded photograph as in FIG. 15.

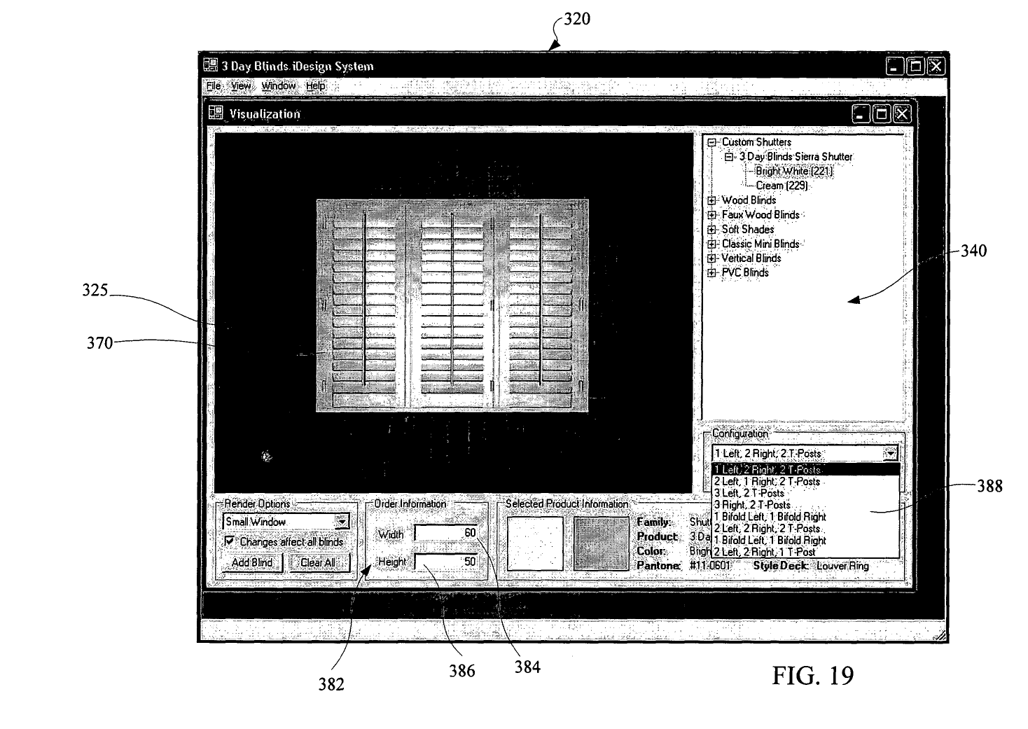

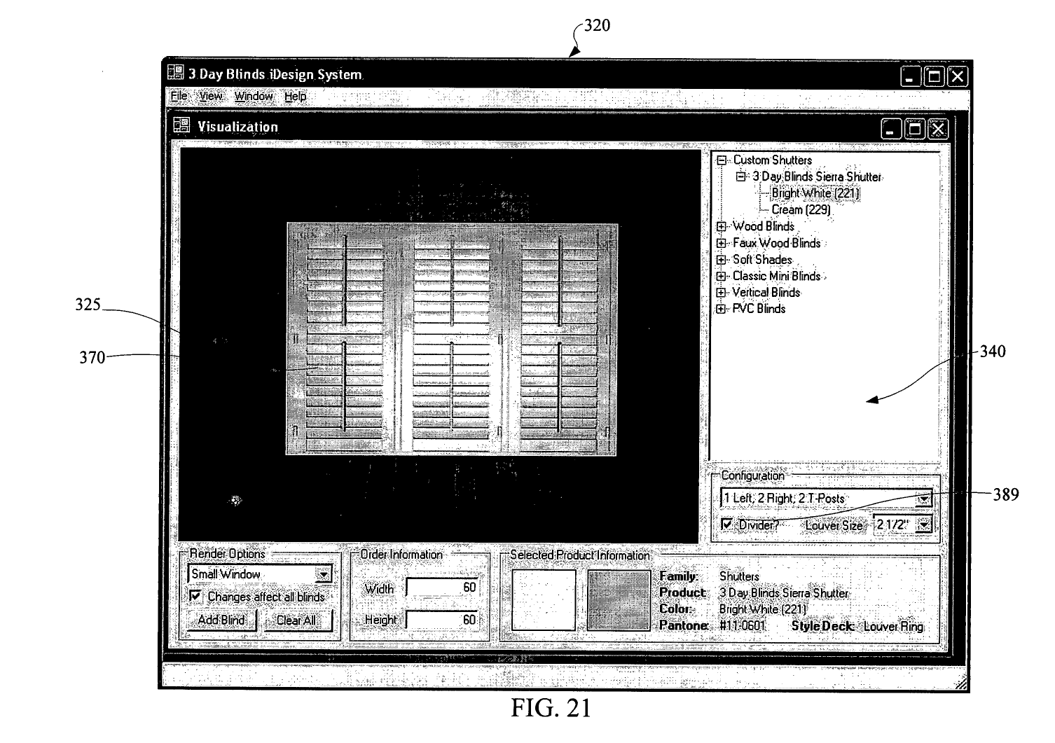

The exemplary visualization system can display virtually any window covering product, including top down and/or bottom up blinds, vertical blinds, shutters, translucent blinds, etc. Certain window covering products have unique characteristics that require special processing. For example, shutters are only available in certain sizes. To account for this, in exemplary embodiments, such as the one shown in the FIG. 19, the user enters shutter dimensions (width 384 and height 386) in an order information area 382. The user also selects a desired product from the product tree 340. The selected product includes the louver size (e.g., two inches). If the user has selected shutters and entered sizes in the order information area 382, a shutter configuration box 388 is displayed. The shutter configuration information is based on the entered dimensions (width 384 and height 386) as well as the louver size. The user selects the desired configuration from the configuration list 388. The window region 370 of the photograph 325 is updated to reflect the selected shutter configuration. In exemplary embodiments, the selected shutter configuration can be viewed with a divider rail by selecting a Display Divider Rail option 389. The shutters shown in FIG. 19 do not include a rail divider. In contrast, the shutters shown in FIG. 21 are displayed with a divider because the user selected a Divider option 389 indicating the shutters should be displayed with a divider.

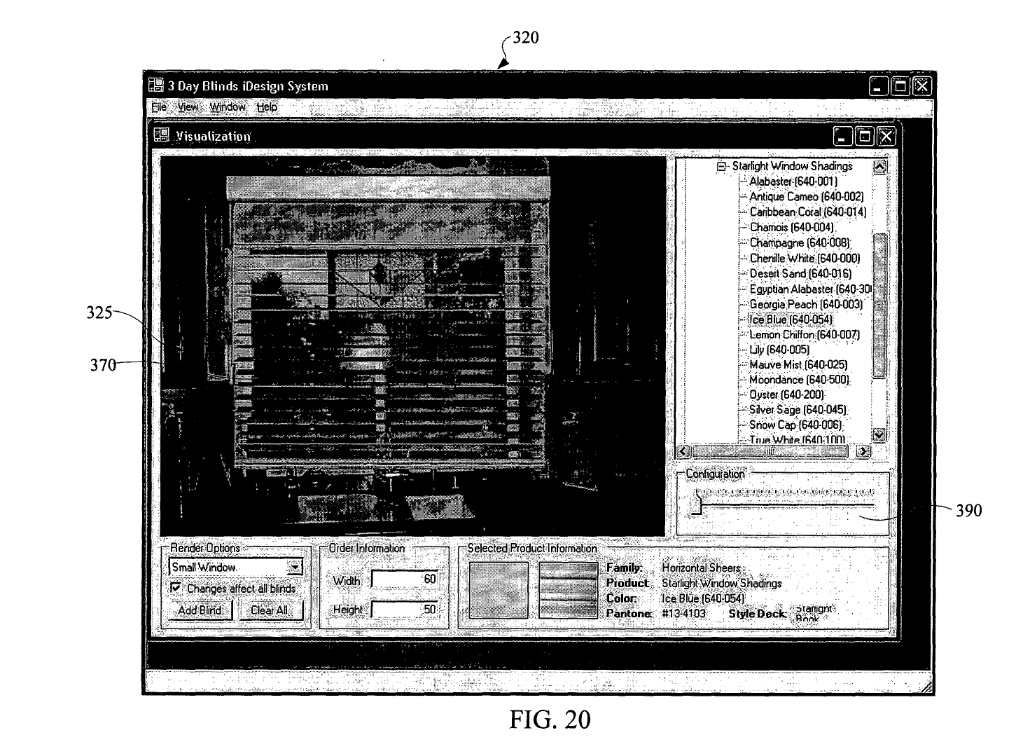

If the window treatment to be visualized is a translucent (sheer) product, such as is shown in the example shown in FIG. 20, the window blind is drawn normally and a transparency bar 390 is displayed. The user slides the transparency bar 390 to adjust the translucency of the displayed blinds. In the embodiment shown, the transparency bar 390 is slid to the right to make the window blind less translucent or to the left to make the window blind appear more translucent in order to see more or less of the room photo through the blind.

In exemplary embodiments, the visualization system described above can be tied in to a Point of Sales (POS) system. When the prospective customer selects a desired product, the product can be ordered.

The visualization system described herein is with reference to an at-home representative that travels to a prospective customer's home or office. The at-home representative brings a digital camera and takes one or more pictures of the room setting including the window(s) on which the window coverings are to be displayed. Preferably, the at-home representative also brings a color deck or book and a product swatch book or deck so that the user can see samples of the various colors and materials. The at-home representative also brings a portable computer, such as a laptop computer on which the visualization program described above is loaded and executed. The digital photographs of the prospective customer's room setting can be accessed directly from the digital camera or they can be stored on a hard disk of the personal computer or on a floppy disk that can be accessed by the personal computer.

While the embodiment shown and described herein is with reference to window coverings, it will be appreciated that the method can be used for the visualization of other home décor products, such as area rugs, carpet, throw pillows and furniture, such as sofas and chairs.

While the visualization system described herein is ideally suited for use by at-home sales representatives as described above, it will be appreciated that the system or alternative embodiments of the system can be used in other ways. For example, the system can be installed at a store. A sales representative could assist the in-store buyer or the in-store buyer could use the system by himself/herself. The prospective customer brings in photos which can be displayed on the in-store system. In exemplary embodiments, such an in-store configuration of the system may use touch screen technology for the user to select various options.

Other embodiments could be implemented on a server that prospective buyers can access from their home (or other location) via the Internet. An at-home representative could store the digital pictures of the prospective customer's room setting on an e-commerce site. The customer could be assigned a user account that allows the prospective customer access to view selected products on the prospective customer's photographs that are stored on the e-commerce web site. In yet other embodiments, the customer could take their own photographs, and visualize various products on their own photographs via an e-commerce web site. In such embodiments, the photographs could be uploaded to the e-commerce web site or stored locally at the prospective customer's site.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

1. A computer implemented method for allowing a user to visualize differing types of window coverings within a room setting, the method comprising:
providing a room setting user interface comprising a plurality of available room settings;
obtaining a selected room setting from the user via the room setting user interface;
providing a product user interface comprising a plurality of available products;
obtaining a selected product from the user via the product user interface;
providing a color user interface comprising a plurality of available colors for the selected product;
obtaining a selected color from the user via the color user interface; and
displaying a visualization of the selected product in the selected color in the selected room setting.

2. The method of claim 1, wherein the color user interface comprises a color wheel displaying the selected color and a plurality of colors related to the selected color.

3. The method of claim 2, wherein the color user interface comprises color variation strips based on colors displayed in the color wheel.

4. The method of claim 2, wherein the color user interface highlights colors that have matching products.

5. The method of claim 1, wherein the selected room setting is a pre-stored glamour photograph.

6. The method of claim 1, wherein the selected room setting is a photograph of the user's room setting.

7. The method of claim 6, wherein the user indicates a window location in the photograph using a pointing device.

8. The method of claim 6, wherein the user indicates a plurality of window locations in the photograph using a pointing device.

9. The method of claim 8, wherein the displaying the visualization of the selected product in the selected color in the selected room setting comprises displaying different selected products in different window locations.

10. The method of claim 8, wherein the displaying the visualization of the selected product in the selected color in the selected room setting comprises displaying different colors of the selected products in different window locations.

11. The method of claim 6, wherein the photograph of the user's room setting is a digital photograph.

12. The method of claim 11, wherein the digital photograph is stored on a digital camera and accessed from the digital camera.

13. The method of claim 11, wherein the digital photograph is stored on a disk accessible by the computer on which the method is implemented.

14. The method of claim 1, wherein a touch screen is used to obtain user input.

15. The method of claim 1, wherein the method is implemented on a portable computer.

16. The method of claim 15, wherein the portable computer is a laptop computer.

17. The method of claim 1, wherein the selected product is translucent.

18. The method of claim 17, wherein a level of transparency is adjustable by the user.

19. The method of claim 1, wherein the computer implemented method is implemented on a server that can be remotely accessed by the user over a network.

20. The method of claim 19, wherein the network is an Internet.

21. The method of claim 1, further comprising ordering the selected product in the selected color.

22. A computer implemented method for allowing a user to visualize differing types of a home decor product within a room setting, the method comprising:
providing a room setting user interface comprising a plurality of available room settings;
obtaining a selected room setting from the user via the room setting user interface;
providing a home décor product user interface comprising a plurality of available home décor products;
obtaining a selected home decor product from the user via the home décor product user interface;
providing a color user interface comprising a plurality of available colors for the selected home décor product;
obtaining a selected color from the user via the color user interface; and
displaying a visualization of the selected home décor product in the selected color in the selected room setting.

23. The method of claim 22, wherein the home décor product is a window covering.

24. The method of claim 22, wherein the home décor product is an area rug.

25. The method of claim 22, wherein the home décor product is a carpet.

26. The method of claim 22, wherein the home décor product is a throw pillow

27. The method of claim 22, wherein the color user interface comprises a color wheel displaying the selected color and a plurality of colors related to the selected color.

28. The method of claim 27, wherein the color user interface comprises color variation strips based on colors displayed in the color wheel.

29. The method of claim 27, wherein the color user interface highlights colors that have matching home décor products.

30. The method of claim 22, wherein the selected room setting is a pre-stored glamour photograph.

31. The method of claim 22, wherein the selected room setting is a photograph of the user's room setting.

32. The method of claim 31, wherein the user indicates a home décor product location in the photograph using a pointing device.

33. The method of claim 31, wherein the user indicates a plurality of home décor product locations in the photograph using a pointing device.

34. The method of claim 33, wherein the displaying the visualization of the selected product in the selected color in the selected room setting comprises displaying different selected home décor products in different home décor product locations.

35. The method of claim 33, wherein the displaying the visualization of the selected product in the selected color in the selected room setting comprises displaying different colors of the selected products in different home decor locations.

36. The method of claim 31, wherein the photograph of the user's room setting is a digital photograph.

37. The method of claim 36, wherein the digital photograph is stored on a digital camera and accessed from the digital camera.

38. The method of claim 36, wherein the digital photograph is stored on a disk accessible by the computer on which the method is implemented.

39. The method of claim 22, wherein a touch screen is used to obtain user input.

40. The method of claim 22, wherein the method is implemented on a portable computer.

41. The method of claim 40, wherein the portable computer is a laptop computer.

42. The method of claim 22, wherein the computer implemented method is implemented on a server that can be remotely accessed by the user over a network.

43. The method of claim 42, wherein the network is an Internet.

44. The method of claim 22, further comprising ordering the selected home décor product in the selected color.
